(19) United States
(12) Patent Application Publication
(10) Pub. No.: US 2010/0106512 A1
(43) Pub. Date: Apr. 29, 2010

(54) MANAGING USER IDENTITY IN COMPUTER GENERATED VIRTUAL ENVIRONMENTS

(76) Inventors: Arn Hyndman, Ottawa (CA); Albert Reiche, Kanata (CA)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 12/259,552

(22) Filed: Oct. 28, 2008

(51) Int. Cl. G06Q 10/00

(52) U.S. Cl. 705/1.1

(57) ABSTRACT

The present application relates to a virtual environment that is capable of using data stored on external content servers to help at least one participant in the virtual environment identify one or more other participants in the same virtual environment. One example of external content server is a social networking server of a social networking site such as Facebook™, Myspace™, LinkedIn™ and Cyworld™, which stores millions of detailed user profiles.

### FIELD OF THE APPLICATION

The present application relates to virtual environments and, more particularly, to a method and apparatus for managing user identity in computer-generated virtual environments.

### BACKGROUND OF THE APPLICATION

A virtual environment is typically a multi-dimensional computer simulated environment that is used to facilitate interaction between two or more participants. In operation, each of the virtual environment participants runs a virtual environment client on a computing device that communicates with a virtual environment server over a computer network, such as a local area network or wide area network. Interaction between virtual environment participants in the virtual environment is facilitated by avatars, which are characters representing the participants. Each participant in the virtual environment has their own avatar and may customize its appearance to their choosing by selecting from various hairstyles, outfits, skin tones, gender, facial features and the like. Movements and interaction of an avatar in the virtual environment is controlled by the corresponding participant by using a combination of input/output devices such as a computer mouse, keyboard, audio headset and microphone. Context in which virtual environments may be used is in connection with gaming, although other uses for virtual environments are being developed. For example, virtual environments are being used to simulate real life environments that enable online education, training, shopping and other types of interactions between groups of users, between businesses and users, and between businesses.

The benefits of virtual environments are numerous, however, there are deficiencies. In many instances, each virtual environment is its own isolated island where participants existing in one virtual environment would have no presence outside of the virtual environment. Consequently, participants of a typical virtual environment may not make automatic use of external information to help identify other participants in the virtual environment and might instead restrict themselves to the user account information within their present virtual environment. This is inefficient, especially when considering that the onset of the information age has led to the creation of numerous social networking sites and virtual environments where millions of detailed user profiles are already in existence. Further, by requiring a separate user account for each virtual environment, privacy becomes a concern since participant identifiable information is exposed to more virtual environment operators and participants must trust that all operators will keep their information private. Additionally, unlike social networking sites, current virtual environments do not specialize in controlling access to user profile data. As a result, a user in the virtual environment may not have sufficient granular control over information access of their personal data.

As such, there is still a need for an efficient technique to support identity management and privacy in association with virtual environments.

### BRIEF DESCRIPTION OF THE DRAWING FIGURES

Aspects of the present application are pointed out with particularity in the appended claims as granted. The present application is illustrated by way of example in the following drawings in which like references indicate similar elements. The following drawings disclose various embodiments of the present application for purposes of illustration only and are not intended to limit the scope of the application. For purposes of clarity, not every component may be labeled in every figure. In the figures:

FIG. 1 is a functional block diagram of a portion of an example system enabling users to have access to multi dimensional computer-generated virtual environment;

FIG. 2 is a second functional block diagram of a portion of an example system enabling users to have access to multi dimensional computer-generated virtual environment.

FIG. 3 is a flow diagram outlining the basic operation of one embodiment of the present application.

FIG. 4 is a second flow diagram outlining the basic operation of one embodiment of the present application; and

FIG. 5 shows an example multi-dimensional computer-generated virtual environment representing a display of external user profile data to identify a participant in a computer-generated virtual environment.

### DETAILED DESCRIPTION OF THE PREFERRED EMBODIMENTS

The embodiments set forth below represent the necessary information to enable those skilled in the art to practice the application and illustrate the best mode of practicing the application. Upon reading the following description in light of the accompanying drawing figures, those skilled in the art will understand the concepts of the application and will recognize applications of these concepts not particularly addressed herein. It should be understood that these concepts and applications fall within the scope of the disclosure and the accompanying claims.

The present application relates to a virtual environment that is capable of using data stored on external content servers to help at least one participant in the virtual environment identify one or more other participants in the same virtual environment. One example of an external content server is a social networking server of a social networking site such as Facebook™, Myspace™, LinkedIn™ Cyworld™, Yahoo Instant Messenger™ and Windows Live Messenger™ which stores millions of detailed user profiles. In today's information age, a participant in a virtual environment is likely to have a user profile on an external content server that could be used by a virtual environment to better identify the participant.

In the virtual environment, the client of each participating user generates a unique identifier and a public screen name on startup. As an example, the identifier is a session token that is in the standardized UUID format and is randomly generated to ensure that each client has a unique identifier. When a first participant encounters a second participant in a virtual environment, the virtual environment server passes the UUID of the second participant to the first participant. If the first participant wants to identify the second participant, then the first participant's client performs a search for that UUID in a local cache storage or one or more external content servers to determine if there exist any friends, associates, and publicly advertised people on external sites/environments that can identify the second participant. If the virtual environment client finds no matches then the second participant's virtual environment user profile and public screen name is used to identify the participant. If one or more matches are found then one or more of the user profiles of the second participant are labeled in the virtual environment to help the first participant identify the second. Preferably, a user interface is used by the first participant to support the displaying of multiple user profiles of the second participant to the first.

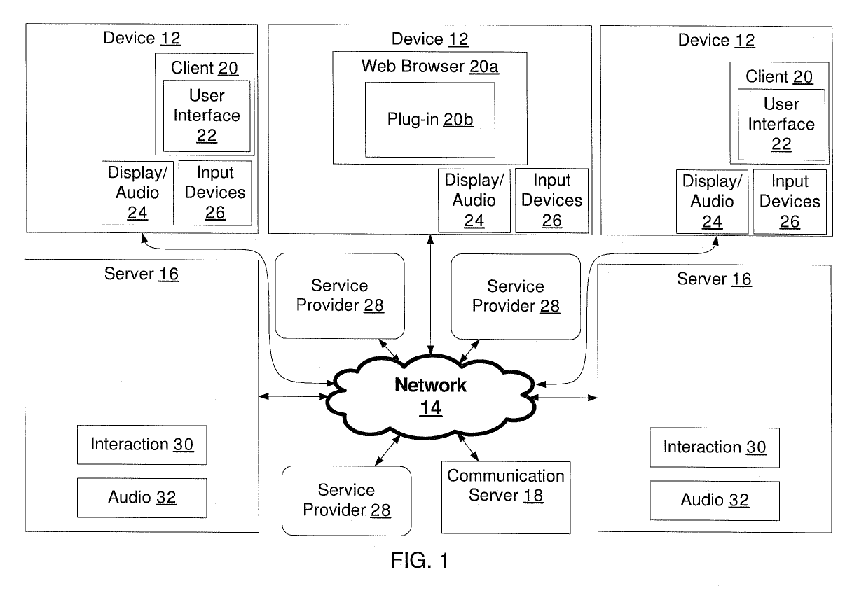

FIG. 1 shows a portion of an example system 10 showing the interaction between a plurality of users of computing devices 12 and one or more virtual environments. A user may access the virtual environment from their computing device 12 over a packet network 14 or other common communication infrastructure. Communication sessions such as audio calls between the users of the computing devices 12 may be implemented by one or more communication servers 18.

The virtual environment may be implemented as using one or more instances, each of which may be hosted by one or more virtual environment servers 16. Where there are multiple instances, the Avatars in one instance are generally unaware of Avatars in the other instance. Conventionally, each instance of the virtual environment may be referred to as a separate world. A world may be implemented by one virtual environment servers 16, or may be implemented by multiple virtual environment servers. According to an embodiment of the application, as described in greater detail below, a replication zone may be defined within the virtual environment. The replication zone will enable objects and Avatars that enter the replication zone to be present in each instance of the virtual environment that also incorporates an associated replication zone. Thus, when an Avatar enters the replication zone, the Avatar is visible to users in multiple instances, and preferably all instances, of the virtual environment. Similarly, where different slices of the virtual environment are supported by different servers, the replication zone can exist in each of the slices such that the Avatar and other objects within the replication zone are visible to different sets of users at different locations within the virtual environment. This enables a single Avatar to interact with and be visible to a larger group of Avatars/users than would otherwise be possible.

The virtual environment may be any type of virtual environment, such as a virtual environment created for an on-line game, a virtual environment created to implement an on-line store, a virtual environment created to implement an on-line training facility, or for any other purpose. Virtual environments are being created for many reasons, and may be designed to enable user interaction to achieve a particular purpose. Example uses of virtual environments include gaming, business, retail, training, social networking, and many other aspects. Generally, a virtual environment will have its own distinct three dimensional coordinate space.

Avatars representing users may move within the three dimensional coordinate space and interact with objects and other Avatars within the three dimensional coordinate space. The virtual environment servers maintain the virtual environment and generate a visual presentation for each user based on the location of the user's Avatar within the virtual environment. The view may also depend on the direction in which the Avatar is facing and the selected viewing option, such as whether the user has opted to have the view appear as if the user was looking through the eyes of the Avatar, or whether the user has opted to pan back from the Avatar to see a three dimensional view of where the Avatar is located and what the Avatar is doing in the three dimensional computer-generated virtual environment.

Each user has a computing device 12 that may be used to access the multi-dimensional computer-generated virtual environment. The computing device 12 will run a virtual environment client 20 and a user interface 22 to the virtual environment. Notably, the virtual environment client 20 may be a stand-alone software package or may alternatively be a thin client that simply requires the use of an Internet web browser 20a such as Microsoft's Internet Explorer and an optional browser plug-in 20b. A separate virtual environment client may be required for each virtual environment that the user would like to access, although a particular virtual environment client may be designed to interface with multiple virtual environment servers 16. The virtual environment client also enables the user to communicate with other users who are also participating in the multi dimensional computer-generated virtual environment. The communication portion of the client may be a separate process running on the computing device 22.

The user may see a representation of a portion of the multi dimensional computer-generated virtual environment on a display/audio 24 and input commands via a user input device 26 such as a mouse, touch pad, or keyboard. The display/audio 24 may be used by the user to transmit/receive audio information while engaged in the virtual environment. For example, the display/audio 24 may be a display screen having a speaker and a microphone. The user interface generates the output shown on the display 24 under the control of the virtual environment client 20, and receives the input from the user via the user input device 26 and passes the user input to the virtual environment client. The virtual environment client passes the user input to the virtual environment server 16 which causes the user's Avatar or other object under the control of the user to execute the desired action in the virtual environment. In this way the user may control a portion of the virtual environment, such as the person's Avatar or other objects in contact with the Avatar, to change the virtual environment for the other users of the virtual environment.

Typically, an Avatar is a three dimensional rendering of a person or other creature that represents the user in the virtual environment. The user selects the way that their Avatar looks when creating a profile for the virtual environment and then can control the movement of the Avatar in the virtual environment such as by causing the Avatar to walk, run, wave, talk, or make other similar movements.

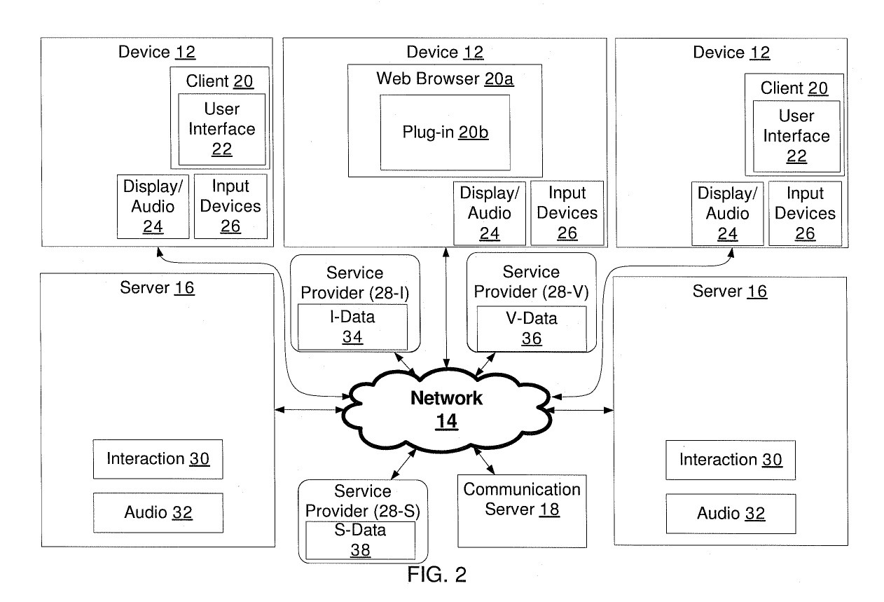

As shown in FIG. 2, the virtual environment client20 is in communication with one or more external content service provider servers 28. The external content servers are generally referenced with the numeral 28; however, different types of content servers are specifically identified when desired with a letter S, I or V. In particular, a social networking content server 28-S primarily stores detailed user profile data 38 of users in the social networking site, such information includes, for example, the user's name, location, birthdate, school, employer, hobbies, pictures and relationships with other users of the site, and other like information. The instant messaging server 28-I stores instant information 34, such as a buddy list of users, for each user to identify which users a user has a relationship with, and for other like information. The virtual environments server 28-V is a virtual environment server that is distinct from the virtual environment server 16 and includes virtual information 36, such as a distinct set of user accounts, and other like information.

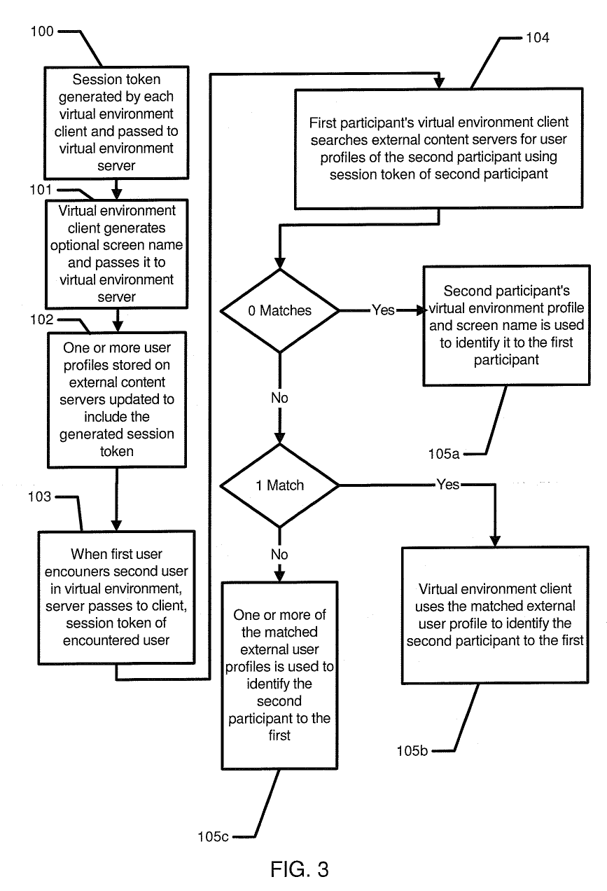

Turning now to the communication flow of FIG. 3, an exemplary embodiment is provided to illustrate one technique for using external content servers 28 to identify a user in a virtual environment. In the embodiment shown in FIG. 3, Steps 100-102, enable registering user identifiable session tokens and steps 103-105e using the token to identify a user. A given user of a virtual environment may use one or both set of steps depending on the particular context. For example, a first user may generate a token that is used by a second user to identify the first user.

Further, in this exemplary embodiment, when a virtual environment client starts up on a user computing device, a user identifier, such as a session token, is generated by each virtual environment client (step 100). Preferably, the session token is in the form of an Open Software Foundation (OSF) standardized Universally Unique Identifier (UUID). The virtual environment client also generates an optional public screen name (step 101) and passes it along with the generated session token to the virtual environment server for storage. The screen name is a public identifier that the user creates and as further described below, may be used in addition to their virtual environment user profile data, to identify the user in the virtual environment.

At this step, the user's profiles stored on external content servers may be manually or automatically updated to include the generated session token (step 102). For example, a user may manually publish their session token in a visible or hidden field in their contact information section of their Facebook™ user profile. In addition to publishing the session token, the user status in these external profiles may be automatically updated to reflect the location of the participant in the virtual environment. Each session token may be associated with a time-to-live value, where after the value has elapsed in time, the token becomes invalid and may be manually or automatically removed from the user's profiles on the external content servers.

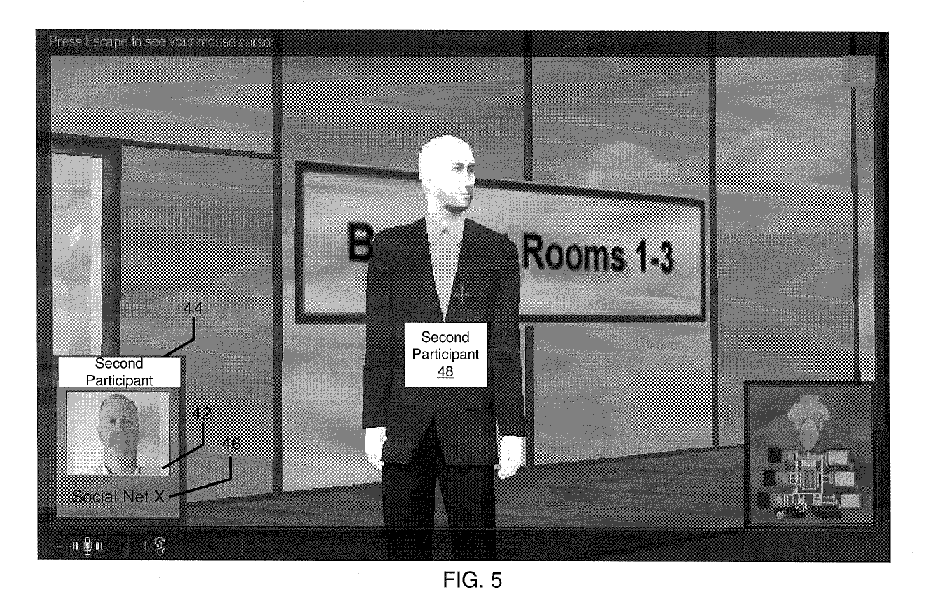

When a first participant encounters a second participant, the virtual environment server passes the encountered second participant's session token to the first participant's virtual environment client (Step 103). If the first participant wants to identify the encountered second participant, the virtual environment client of the first participant searches one or more external content servers for user profiles of the second participant, using the session token of the second participant as the main search criteria (Step 104). Notably, the virtual environment client performs the search rather than the server to prevent exposing profile data to a server that may not be trusted. The searching technique used, may be similar to the people search functionality used by the Wink™ social search engine where specified criteria is used to search for users in popular social networking sites such as those previously defined. If the virtual environment client cannot find a match then the second participant's virtual environment profile and screen name is used to identify it to the first participant (Step 105a). If the virtual environment client finds a single match then the virtual environment client uses the matched external user profile to identify the second participant to the first (Step 105b). If a plurality of matches are found then one or more of the matched external user profiles is used to identify the second participant to the first (Step 105c). Such user profile data may be in the form of text, audio, video, voice and photo, image, or other data. For example, as shown in FIG. 5, the user profile data is in the form of a photo 42 and text 44, where the photo 42 is a picture of a participant and the text 44 is the name of the participant. The badge display 46 has a background that indicates where the profile data came from, where in this example, the data came from a fictional social network X. Notably, the badge background indicates to the user which external network/environment is vetting for the user and thus establishes a level of trust. For example, if a widely trusted source such as Verisign™ was vetting for the second participant, the first participant might trust that the text 44 is the second participant's real name whereas, if the source was Live Messenger™, the first participant might expect that the text 44 is simply some kind of alias of the participant.

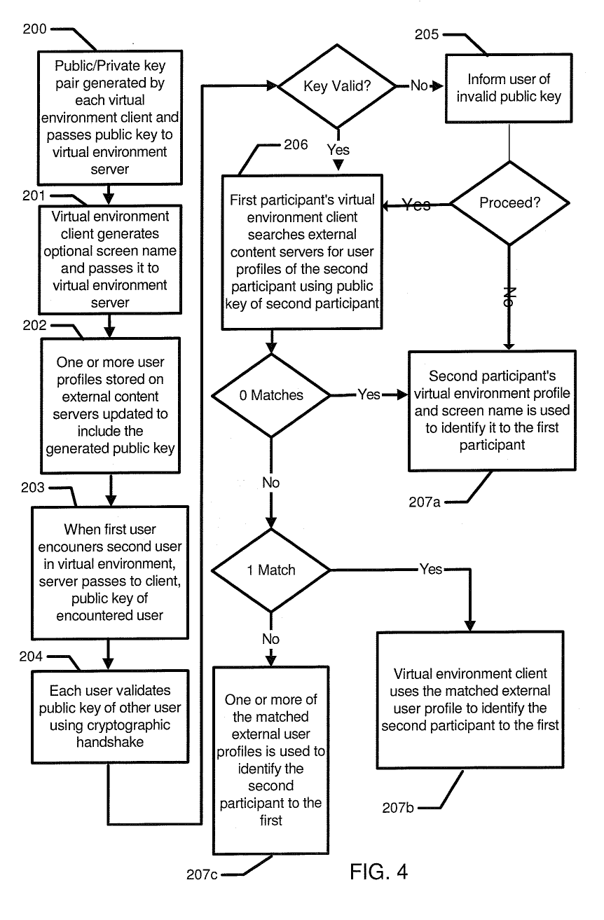

The UUID solution outlined above may be vulnerable to identity spoofing if the virtual environment client software is hacked. This can be solved with a slightly more sophisticated cryptographic solution shown in FIG. 4. Specifically, the client generates an anonymous public/private key pair as its user identifier instead of a simple UUID and passes the public key to the virtual environment server (Step 200). Notably, the anonymous public key does not contain the identity of the user and is generated at startup of the virtual environment client without the use of personal data. The virtual environment client also generates an optional public screen name (step 201) and passes it along with the generated anonymous public key to the virtual environment server for storage. The screen name is a public identifier that the user creates and will be used, in addition to their virtual environment user profile data, to identify the user in the virtual environment if alternative user profile data cannot be found on external content servers. At this step, the user's profiles stored on external content servers may be manually or automatically updated to include the generated anonymous public key (step 202). For example, a user may manually publish their public key in a hidden field of their contact information section of their Facebook™ user profile. In addition to publishing the public key, the user status in these external profiles may be automatically updated to reflect the location of the participant in the virtual environment. Each public key may be associated with a time-to-live value where after the value has elapsed in time, the token becomes invalid and may be manually or automatically removed from the user's profiles on the external content servers.

When a first participant encounters a second participant, the virtual environment server passes the second participant's public key to the first participant's virtual environment client (Step 203). If the first participant wants to identify the encountered second participant, the first participant first verifies that the received public key of the second participant corresponds to the encountered second participant using well known cryptographic handshake algorithms (Step 204). If the public key does not belong to the encountered second participant then a warning message is sent to the first participant informing the first participant of the mismatch and asking if the first participant wishes to proceed (Step 205). If the first participant does not wish to proceed then the virtual environment profile and screen name is used to identify the second participant (Step 207a). If the first participant wishes to proceed or it is verified that the public key belongs to the second participant, the virtual environment client of the first participant searches one or more external content servers for user profiles of the second participant, using the public key of the second participant as the main search criteria (Step 206). If the virtual environment client cannot find a match then the second participant's virtual environment profile and screen name is used to identify it to the first participant (Step 207a). If the virtual environment client finds a single match then the virtual environment client uses the matched external user profile to identify the second participant to the first (Step 207b). If a plurality of matches are found then one or more of the matched external user profiles is used to identify the second participant to the first (Step 207c).

The searched user profile data is stored at the virtual environment client with the corresponding user's identifier as the key to the data. Preferably, the user profile data is stored in a hash table with the corresponding user identifier as a key to the data. The user identifiers, such as session tokens and public keys, may be cached at the virtual environment client. As an alternative to searching external content servers, a participant's virtual environment client may use cached user identifiers such that when a second participant is encountered, the first participant can look up the encountered second participant's user identifier in its cached data. If the user identifier is not found then the client may fall back to the external content server search described above.

Preferably, the plurality of search results is ranked using a set of rules that can be dynamically or statically configured by the administrator. For example, a rule set might dynamically or statically prioritize each external content server in such a manner that user profiles from higher priority content servers are passed on to the user in the virtual environment and user profiles from lower priority sites are discarded. Alternatively, well known abstractions of organizing data such as the FIFO and LIFO abstractions, may be used to determine the order of profiles presented to the users. Furthermore, search results may be organized based upon contextual information of the virtual environment participant. For example, a participant in an office setting within the virtual environment may have their Linkedin™ profile presented, while a participant in a public setting within the virtual environment may have their Facebook™ or Myspace™ profile presented. Each user in the virtual environment can manage the plurality of user profiles from external content servers from within the virtual environment client interface and customize the identity of the identified user. Finally, steps 103-105 and 203-207 may be repeated periodically or asynchronously on-demand, and a notification based mechanism may be adopted to present new user profiles to the user.

It should be understood that various changes and modifications of the embodiments shown in the drawings and described in the specification may be made within the spirit and scope of the present application. Accordingly, it is intended that all matter contained in the above description and shown in the accompanying drawings be interpreted in an illustrative and not in a limiting sense. The application is limited only as defined in the following claims and the equivalents thereto.

What is claimed is:

1. A method of managing identity in computer-generated virtual environments, the method comprising the steps of:
(a) encountering a user in the virtual environment;
(b) obtaining a user identifier of the user; and
(c) conducting a search based on the user identifier to obtain at least a portion of one or more user identity profiles responsive to the search.

2. A method of managing identity in computer-generated virtual environments of claim 1, wherein the search is performed on one or more external content servers.

3. A method of managing identity in computer-generated virtual environments of claim 1, wherein the search is performed on a local cache storage.

4. The method of managing identity in computer-generated virtual environments of claim 1, further comprising the step of:
presenting the one or more user identity profiles.

5. The method of managing identity in computer-generated virtual environments of claim 4, further comprising the step of:
presenting an identifier of the external content server corresponding to each of the one or more user identity profiles.

6. The method of managing identity in computer-generated virtual environments of claim 1, further comprising the step of:
presenting a public screen name of the user.

7. The method of managing identity in computer-generated virtual environments of claim 1, wherein a user identity profile is not found.

8. The method of managing identity in computer-generated virtual environments of claim 1, wherein the one or more external content server includes at least one of: an instant messaging server, social networking server and virtual environment server.

9. The method of managing identity in computer-generated virtual environments of claim 1, wherein the user identifier is related to a user session token.

10. The method of managing identity in computer-generated virtual environments of claim 5, wherein the user session token is related to a Universally Unique Identifier.

11. The method of managing identity in computer-generated virtual environments of claim 1, wherein the virtual environment supports cryptography.

12. The method of managing identity in computer-generated virtual environments of claim 11, wherein the virtual environment supports asymmetric cryptography.

13. The method of managing identity in computer-generated virtual environments of claim 12, wherein the user identifier is related to an anonymous public key and private key pair.

14. The method of managing identity in computer-generated virtual environments of claim 13, wherein the anonymous public key is used to verify that the key belongs to the user.

15. The method of managing identity in computer-generated virtual environments of claim 1, further comprising receiving a public screen name for the user.

16. The method of managing identity in computer-generated virtual environments of claim 1, further comprising updating the user's profile on the one or more external content servers to contain a reference to the user identifier.

17. The method of managing identity in computer-generated virtual environments of claim 16, further comprising updating the user's profile on the one or more external content servers to remove the reference to the user identifier.

18. The method of managing identity in computer-generated virtual environments of claim 17, wherein the user's status on their user profile stored on the one or more external content server is automatically updated to reflect the user's location in the virtual environment.

19. The method of managing identity in computer-generated virtual environments of claim 1, further comprising periodically repeating of steps (a) to (c).

20. The method of managing identity in computer-generated virtual environments of claim 19, further comprising notifying the availability of the search results from each periodic repeat.

21. The method of managing identity in computer-generated virtual environments of claim 4, further comprising extracting specific user identifiable data from the search results and presenting the data to the user.

22. The method of managing identity in computer-generated virtual environments of claim 1, wherein the search is conducted over the Internet.

23. The method of managing identity in computer-generated virtual environments of claim 4, wherein the plurality of user profile data includes at least one of the following types: text, audio, video, voice, infocard, photo and image.

24. The method of managing identity in computer-generated virtual environments of claim 4, wherein the at least a portion of content items is ranked based on ranking criteria.

25. The method of managing identity in computer-generated virtual environments of claim 24, wherein at least a portion of the search results are ranked based upon dynamic rule sets.

26. The method of managing identity in computer-generated virtual environments of claim 24, wherein at least a portion of the search results are ranked based upon static rule sets.

27. The method of managing identity in computer-generated virtual environments of claim 5, further comprising generating the user identifier and the public screen name at the user terminal for each virtual environment user each time a virtual environment client in the user terminal starts up.

28. A system comprising: at least one communication interface; and a control system associated with the at least one communication interface and adapted to:
encounter a user in the virtual environment;
obtain a user identifier of the user;
conduct a search based on the user identifier to obtain at least a portion of one or more user identity profiles responsive to the search; and
present the one or more user identity profiles of the user, wherein
when an identity profile is not found, displaying a public screen name of the user.
